(19) United States
(12) Patent Application Publication
(10) Pub. No.: US 2026/0261799 A1
(43) Pub. Date: Sep. 3, 2026

(54) SOFTWARE PROTECTION FOR SEAT EXCITORS

(71) Applicant: HARMAN BECKER AUTOMOTIVE SYSTEMS, INC., Novi, MI (US)

(72) Inventors: Zhijun CHEN, Kanagawa (JP); Sunil Ravinda SHUKLA, Dublin, CA (US); Qiang ZHANG, Suzhou (CN); Daliang WU, Suzhou (CN)

(21) Appl. No.: 19/547,324

(22) Filed: Feb. 23, 2026

(30) Foreign Application Priority Data
Feb. 28, 2025 (CN) 202510241984.0

(51) Int. Cl. H04R 3/00; H04R 3/04; H04R 29/00

(52) U.S. Cl. CPC H04R 3/007; H04R 3/04; H04R 29/001; H04R 2430/01

(57) ABSTRACT

Various embodiments disclose computer-implemented method for excitor protection in a multimedia system including receiving an audio output signal associated with an audio input signal, determining an excitor specification associated with an excitor, wherein the excitor specification specifies one or more operating parameters, and generating an excitor output signal based on the excitor specification.

### CROSS REFERENCE TO RELATED APPLICATIONS

This application claims priority benefit of Chinese Patent Application Number 202510241984.0, entitled “SOFTWARE PROTECTION FOR SEAT EXCITORS” filed Feb. 28, 2025. The subject matter of this related application is hereby incorporated herein by reference.

### BACKGROUND

### Field of the Various Embodiments

The contemplated embodiments relate generally to protection techniques for seat excitors and speakers and, more specifically, software protection for seat excitors.

### Description of the Related Art

Current audio systems, such as audio systems implemented in a vehicle or theater, process an audio input, such as music played back from a remote or local source, and generate an output that is transmitted to various output devices, such as one or more speakers. In some implementations, an excitor is another type of output devices to which the output is provided. An excitor is also referred to as a seat shaker or a shaker. An excitor is often installed in one or more seats of a vehicle or theater and generates a mechanical vibration or shaking of the seat for a set of frequency ranges. The shaking output enhances the user experience with respect to playback of the audio input. Speaker protection techniques are often utilized to limit or prevent damage to speakers that are utilized in the audio system. Speaker protection techniques are typically implemented by a digital signal processor that processes the audio input before an output signal is generated and transmitted to the speakers.

One drawback of speaker protection techniques is that they are not well suited for excitors because they involve significant signal processing resources. Additionally, excitors operate based on different mechanical principles than a speaker. A speaker is implemented using one or more cones or diaphragms that are driven back and forth by a driver, which creates pressure waves that produce sound. A seat excitor is implemented using one or more vibrators that vibrates in response to an input signal. Accordingly, through extended operation or by causing the excitor to operate outside of a designed operating range, there exists a risk of damage to the excitor that is not appropriate addressed using conventional speaker protection algorithms. For example, an excitor coil can overheat or the excitor can suffer other mechanical or electrical damage. Repairing or replacing a damaged excitor is typically impractical due to the installation of the excitor within a seat or furniture, behind interior panels, underneath flooring, or other generally user-inaccessible locations.

### SUMMARY

Various embodiments disclose computer-implemented method for excitor protection in a multimedia system including receiving an audio output signal associated with an audio input signal, determining an excitor specification associated with an excitor, wherein the excitor specification specifies one or more operating parameters, and generating an excitor output signal based on the excitor specification.

Further embodiments provide, among other things, one or more non-transitory computer-readable media and systems configured to implement the methods set forth above.

At least one technical advantage of the disclosed approach relative to the prior art is that, with the disclosed techniques, excitors are provided with protection without requiring hardware configuration changes to an audio system or the excitor components themselves. Implementing protection in hardware typically increases the unit cost, physical size, and mounting complexity of the excitor, which is a concern given the limited space available in locations where excitors are often installed. Additionally, the disclosed approach can accommodate various types of excitors from various manufacturers with varying operating parameters without reconfiguring the hardware components upstream of the excitors. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of an audio system configured to implement one or more aspects of the present disclosure;

FIG. 2 provides a high-level conceptual diagram illustrating the functional interaction between the excitor protection application, excitor specifications, one or more excitors, and one or more input sources;

FIG. 3 provides an architectural breakdown of the one or more input sources according to one or more aspects of the disclosure; and

FIG. 4 is a flow diagram of method steps for implementing protection techniques for one or more excitors according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

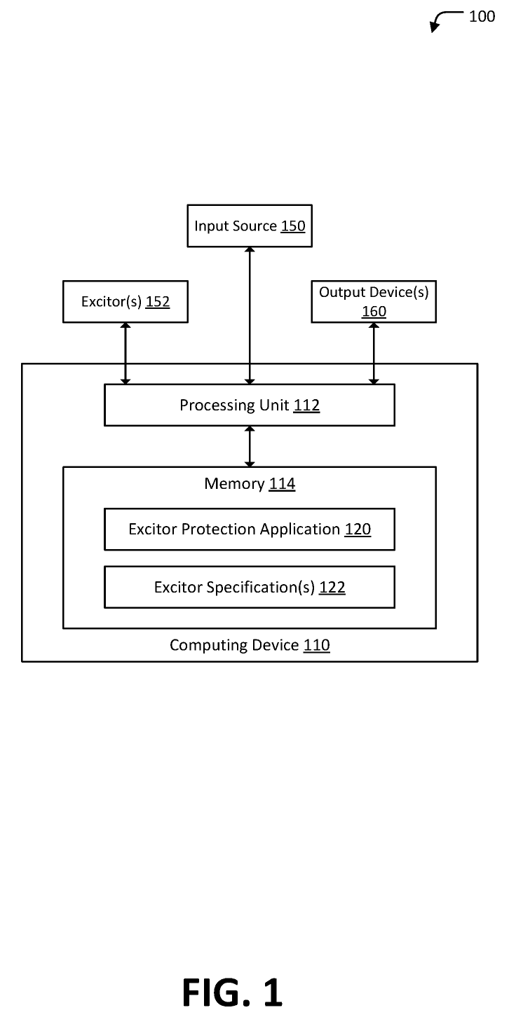

FIG. 1 is a schematic diagram illustrating a multimedia system 100 according to various embodiments. As shown, the multimedia system 100 includes, without limitation, a computing device 110, one or more excitors 152, one or more input sources 150, and one or more output devices 160. The computing device 110 includes, without limitation, a processing unit 112 and memory 114. The memory 114 stores, without limitation, an excitor protection application 120 and excitor specification 122.

Computing device 110 includes, without limitation, any technically feasible device or component capable of receiving an input signal from one or more input sources 150 that is being played back by the multimedia system 100. For example, an input source 150 can include a media player that accesses terrestrial or satellite radio, a streaming service accessed via a network connection, a local media stream (e.g., from a cellular or smart telephone), or a storage device containing music, movie soundtracks, spoken word content, or other audio files. In some embodiments, computing device 110 can adapt or switch audio content based on user preferences, sensor input, system configurations, and/or the like. Computing device 110 processes an audio signal from one or more input sources 150 and drives one or more excitors 152 and/or one or more output devices 160. In some embodiments, the computing device 110 is integrated into a head unit, amplifies, audio processor or other type of device in a vehicle, aircraft, or a fixed environment.

In many environments, such as vehicle cabins or theaters, one or more excitors 152, also referred to as seat shaker, tactile transducers, or panel-based transducers that excite a flat surface such as a pane of glass, are utilized to enhance a viewing or listening experience of audio or multimedia content. An excitor 152 represents one or more devices or components configured to convert an electrical drive signal into mechanical vibrations perceptible to one or more listeners. For example, an excitor 152 includes seat-mounted actuators, voice‑coil shakers, moving‑magnet exciters, linear‑resonant actuators, piezoelectric benders, and/or the like. Each of the one or more excitors 152 can be mounted to, embedded within, or mechanically coupled to a support surface such as a seat base, seatback, headrest, armrest, floor panel, gaming chair platform, and/or the like located within a passenger compartment, home‑theatre environment, wearable assembly, and/or the like. The electrical drive signal is supplied by computing device 110 and is derived from an audio signal generated based on one or more input sources 150 and processed by excitor protection application 120. Excitor 152 can generate vibrations related to any audio signal including bass-heavy music, cinematic audio effects, bass notes, or other audio signal-based vibrations capable of enhancing immersive user experience.

A computing device 110 generates one or more output signals that are used to drive one or more excitors 152 and one or more output devices 160, such as speakers, in a listening or viewing environment. Additionally, the multimedia system 100 generates an excitor output signal that is provided to the one or more excitors 152 to drive the one or more excitors 152 in the system. In various environments, different excitors having different specifications that include different operating parameters and operating ranges are utilized. For example, a first type of excitor with certain operating parameters and operating ranges could be used in the front seats of a vehicle. A second type of excitor with different operating parameters and operating ranges could be used in the rear seats of the vehicle.

The processing unit 112 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of different processing units, such as a CPU configured to operate in conjunction with a GPU and/or a DSP. In general, the processing unit 112 can be any technically feasible hardware unit capable of processing data and/or executing software applications.

Memory 114 can include a random-access memory (RAM) module, a flash memory unit, or any other type of memory unit or combination thereof. The processing unit 112 is configured to read data from and write data to the memory 114. In various embodiments, the memory 114 includes non-volatile memory, such as optical drives, magnetic drives, flash drives, or other storage. In some embodiments, separate data stores, such as an external data store included in a network (“cloud storage”) can supplement the memory 114. The excitor protection application 120 within the memory 114 can be executed by the processing unit 112 to implement the overall functionality of the computing device 110 and, thus, to coordinate the operation of the multimedia system 100 as a whole. Excitor specifications 122 include operating parameters, operating limits, and other parameters from which the excitor protection application 120 can generate an excitor output signal that is consistent with the excitor specification 122 of a respective excitor 152. In various embodiments, an interconnect bus (not shown) connects the processing unit 112, the memory 114, one or more input sources 150, excitors 152, one or more output devices 160, and any other components of the multimedia system 100.

In one implementation, the excitor protection application 120 receives an audio output signal generated by an audio processing element within multimedia system 100 and generates an excitor output signal for each of the respective one or more excitors 152 in the environment. To generate an excitor output signal, excitor protection application 120 implements protection techniques that generate an excitor output signal based on an excitor specification 122 that specifies the operating parameters and operating ranges of a given excitor 152. Accordingly, the excitor protection application 120 generates an excitor output signal that also limits or prevents damage to the one or more excitors 152 based on their respective operating parameters or operating ranges. For example, the excitor protection application 120 can limit the gain of an excitor output signal or mute an excitor output signal provided to an excitor 152 to limit the chance of damage to the excitor 152 based upon the operating parameters of the one or more excitors 152. The excitor protection application 120 is configured with the operating parameters and acceptable operating ranges of a particular excitor 152.

The excitor protection application 120 operates within the memory 114 of the computing device 110 to implement a multi-stage software protection module that prevents damage to seat shakers. The application functions by receiving an audio output signal and processing it through a series of configurable submodules tailored to a specific excitor’s hardware datasheet. The first stage of the application involves a frequency band control (FBC) module, which ensures the signal remains within the mechanical operating range of an excitor 152. The operating range is defined by the respective excitor specification 122 of an excitor 152. Based on the excitor specification, the excitor protection application 120 implements cutoff frequencies to filter out potentially damaging low or high frequencies. If the excitor protection application 120 determines that the possible range of the input signal is already safely within the operating frequency range of the excitor 152, the excitor protection application 120 can disregard or bypass FBC to preserve signal integrity.

Following frequency filtering, excitor protection application 120 applies a dynamic gain limiter to provide peak voltage protection. By referencing the operating voltage parameters in the excitor specification 122, excitor specification 122 limits the peak voltage of the output signal to prevent the excitor coil from overheating or suffering electrical damage. Similar to the FBC module, the excitor protection application 120 can disable gain protection in real-time if the highest possible peak voltage of the source signal is determined to be less than the maximum operating voltage of the excitor 152 based on analysis of the excitor specification 122 corresponding to the excitor 152. Excitor protection application 120 also incorporates Time Window Power Limiter (TWPL) module. TWPL module uses a voltage level detection mechanism to monitor the signal and count historical power levels provided to an excitor 152 within a specific delay window, such as a one-second interval. The excitor protection application 120 sums these window values to create a summed window value and compares the summed window value against a predetermined threshold derived from the excitor's test data. If the sum exceeds percentage-based K-value thresholds, such as a 90% threshold for gain reduction or a 98% threshold for muting, excitor protection application 120 automatically adjusts the signal gain or mutes the output to comply with the on/off ratio and continuous work specifications of a respective excitor 152.

In one embodiment, a user or a developer can configure the excitor protection application 120 based on the excitor specification 122 of one or more excitors 152 that are utilized within an environment. The developer workflow for configuring the excitor protection application 120 involves translating an excitor specification 122 into functional software parameters for the configuring the excitor protection application 120 for a given implementation. The developer workflow begins with gathering the target excitor specification 122 from a manufacturer's datasheet or hardware durable test data. These excitor specifications 122 typically include the one or more excitors 152 respective maximum frequency range, normal operating voltage range, continuous maximum voltage time, and the required on/off ratio for cooling.

A user can configure the excitor protection application 120 by enabling only the specific submodules required for a particular excitor 152. In some examples, excitor protection application 120 can automatically configure the various modules based upon an automated analysis of the excitor specification 122. For example, if the physical mounting or design of one or more excitors 152 already guarantees that the excitor 152 will not exceed certain voltage limits, the dynamic gain limiter might be disabled while the FBC module remains active to manage mechanical vibration limits.

Excitor protection application 120 converts excitor specification 122 into setting parameters, such as software "K-values". This conversion involves translating physical units like volts and minutes into software-readable thresholds for the Time Window Power Limiter (TWPL). For example, a hardware requirement for "40 minutes of work followed by 10 minutes off" is converted into a specific delay window size and corresponding K-values that trigger gain reduction or muting when the summed power window reaches 90% or 98% of the hardware's durability threshold. In some embodiments, excitor protection application 120 is configured into the multimedia system 100 and undergoes unit and system-level verification. A testing phase validates that the excitor protection application 120 correctly interprets the summed window values and applies appropriate gain level decisions to protect the one or more excitors 152 from damage or overheating.

The one or more output devices 160 can be any technically feasible type of audio or video output device. The one or more output devices 160 can include loudspeakers that output sound based on an audio input provided by the computing device 110. The one or more output devices 160 can also include one or more displays that render still or moving images based upon an input from the computing device 110.

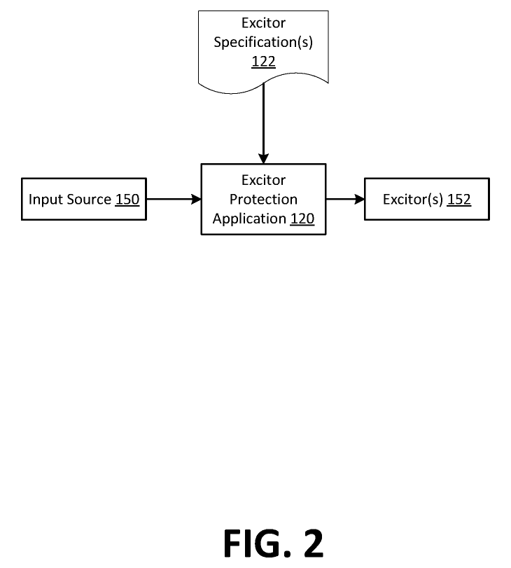

Referring next to FIG. 2, shown is a block diagram showing an example signal flow according to one or more embodiments. FIG. 2 provides a high-level conceptual diagram illustrating the functional interaction between the excitor protection application 120, excitor specifications 122, one or more excitors 152, and one or more input sources 150. FIG. 2 illustrates how one or more input sources 150 operates as a gatekeeper between an input signal from and one or more input sources 150 and one or more excitors 152 of an multimedia system 100 to prevent damage to the one or more input sources 150 by ensuring that an output signal from multimedia system 100 is within the operating parameters of the one or more excitors 152 of the multimedia system 100.

As shown in FIG. 2, the one or more input sources 150 provides an input signal to the one or more input sources 150. The input signal from the one or more input sources 150 corresponds to an audio signal for playback by multimedia system 100. Rather than allowing input signal to drive one or more excitors 152 directly, excitor protection application 120 receives the input signal and processes the input signal into an output based on an analysis of an excitor specification 122 corresponding to a respective excitor 152. In one embodiment, excitor protection application 120 can reference an excitor specification 122 corresponding to the excitor 152 in real time. In another embodiment, the excitor protection application 120 can be configured with operating parameters for driving an excitor 152 upon configuration of the multimedia system 100 and integration of the one or more excitors 152 into the multimedia system 100. As noted above, the excitor specification 122 includes one or more mechanical and electrical tolerances of an excitor 152. These excitor specification 122 includes parameters such as rated voltage, maximum frequency ranges, duty cycle parameters defining how much time within a specified time period the excitor 152 can operates, and other test data or parameters derived from manufacturer data.

By processing the one or more input sources 150 based on a particular excitor specification 122, the excitor protection application 120 can dynamically modify an input signal in real time in some embodiments. In other embodiments, the excitor protection application 120 is pre-configured based on an excitor specification 122 so that the excitor protection application 120 generates an output signal provided to one or more excitors 152 based on the respective operating parameters associated with the excitors 152. In some embodiments, the computing device 110 executes multiple instances of the excitor protection application 120 that are configured to provide output signals to different excitors 152 that can have potentially different excitor specifications 122 specifying varying operating parameters. In this way, the multimedia system 100 can support an installation that includes a heterogeneous set of excitors 152. Accordingly, by configuring the excitor protection application 120 based on one or more excitor specification 122, examples of the disclosure ensure that an output delivered to the excitors 152 is conditioned to remain within safe operating boundaries. Such a configuration prevents the excitors from being driven into states that would cause overheating, mechanical fatigue, or permanent failure.

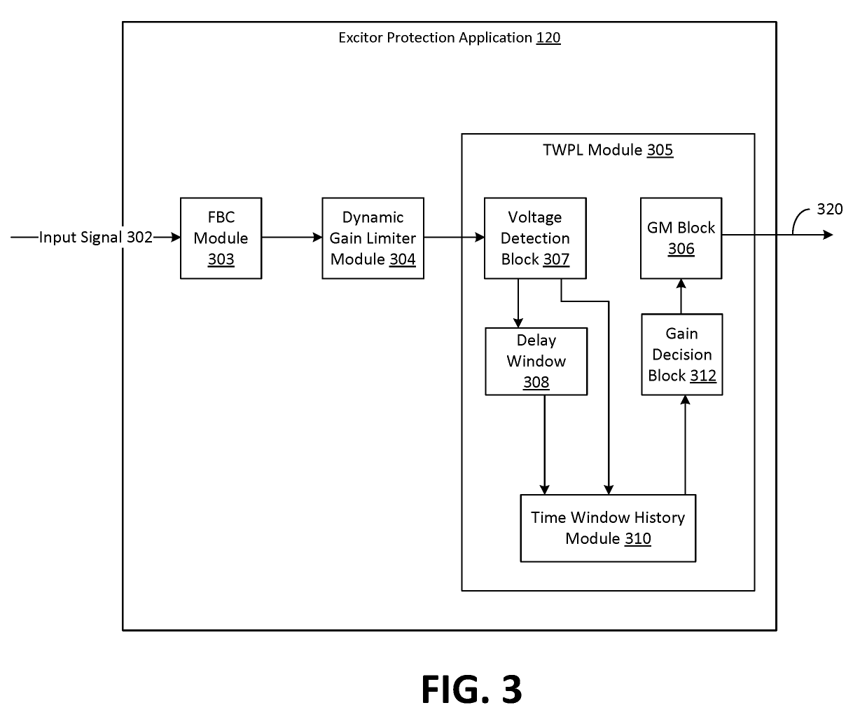

FIG. 3 provides an architectural breakdown of the one or more input sources 150 according to various embodiments. The depiction shown in FIG. 3 illustrates an expansion of the high-level system components and operational relationships previously introduced in FIGS. 1 and 2. FIG. 3 illustrates one example of an internal signal processing pipeline and the logic modules employed to transform an input signal 302, which can correspond to an audio input signal from one or more input sources 150 into a conditioned and protected output signal 320 suitable for one or more excitors 152. The excitor protection application 120, in one implementation, is structured as a sequential, multi-stage digital signal processing chain including three submodules configured to mitigate distinct categories of mechanical, electrical, and thermal hardware risk.

In the depicted example, the input signal 302 is provided to an initial stage of an internal processing chain of the one or more input sources 150, the frequency band control module 303, which receives the input signal 302. In one example, the input signal 302 is received directly from one or more input sources 150. In another embodiment, the input signal 302 represents a processed input signal that corresponds to an excitor signal generated by an upstream component in the multimedia system 100. As established in the system-level overview of FIG. 2, standard audio content sources can provide signals that frequently exceed the physical and mechanical capabilities of a specialized seat excitor. The frequency band control module 303 applies frequency-based constraints specified by the excitor specification 122 associated with an excitor 152 and with which the excitor protection application 120 configures the frequency band control module 303. Frequency band control module 303 applies specific high-pass or low-pass cutoff frequencies so that an output signal provided to the excitor 152 remains within the mechanical operating range defined in the excitor specification 122. Frequency band control module 303 is capable of being enabled or disabled based on whether the source signal is already guaranteed to be within the correct range for the specific hardware. In one embodiment, excitor protection application 120 provides a control signal to frequency band control module 303 instructing frequency band control module 303 to either apply filtering to input signal 302 or to pass through the input signal 302 without modification.

Once the input signal 302 has been appropriately frequency-conditioned by frequency band control module 303, the input signal 302 is transmitted to the dynamic gain limiter module 304. Dynamic gain limiter module 304 is responsible for providing real-time peak voltage protection by monitoring the amplitude or voltage level of the input signal 302 against the predefined operating voltage parameters specified by excitor protection application 120 and with which one or more input sources 150 is configured. By dynamically limiting the peak voltage, this module prevents the excitor coil of an excitor 152 from overheating or suffering electrical damage, which is important for components such as excitors 152 that are often installed in user-inaccessible locations where repair is difficult or practically impossible. The developer workflow allows dynamic gain limiter module 304 to be configured or bypassed via one or more control signals depending on the maximum peak operating voltage of the excitor relative to the potential signal strength. The signal is output from dynamic gain limiter module 304 to TWPL module 305.

TWPL module 305 controls the long-term durability and thermal safety of an excitor 152 by monitoring cumulative usage of the excitor 152 over time. The dynamic gain limiter module 304 receives the output from dynamic gain limiter module 304 and continuously monitors a signal level associated with the signal. The first submodule associated with the TWPL module 305 is the voltage detection block 307, which receives the output signal from the dynamic gain limiter module 304 as its primary input. Voltage detection block 307 outputs continuous, real-time voltage level data that is used to monitor the ongoing electrical stress on the excitor hardware. The voltage data is then fed into the delay window 308, which serves as a temporal buffer. The delay window 308 receives the continuous voltage input and outputs a windowed data set corresponding to a specific time duration, such as a one-second interval, which defines the temporal scope for power calculations.

The windowed data from the delay window 308 and the raw data from the delay window 308 are both provided as inputs to the time window history module 310. The time window history module 310 counts a history of power usage by the excitor 152 over a time period by summing the windowed voltage values. The output of the time window history module 310 is a summed window value, which represents the total cumulative power delivered to the excitor 152 over the specified delay window. The summed window value is then transmitted as an input to the gain decision block 312. The Gain decision block 312 also utilizes internal configuration inputs that are generated and derived from the excitor specification 122, such as Gain down K values or Mute start K values, which represent the threshold percentages of the maximum power capacity of the excitor 152. By comparing the summed window value against K-value thresholds, gain decision block 312 outputs a control command, such as a gain reduction command or a mute instruction, to the GM block 306.

The GM block 306, also referred to as a Gain/Mute stage, receives two inputs: the audio signal stream passing through the TWPL module 305 and a logic-based control command from the Gain decision block 312. GM block 306 operates as a control point, using the control command input to determine the physical state of the signal path. If Gain decision block 312 provides a gain down command because the summed window value has reached a high percentage of a durability threshold associated with an excitor 152, GM block 306 reduces the signal gain. If a durability threshold is exceeded, GM block 306 can mute the input signal. The output of the GM block 306 is a protected excitor output signal 302, which is transmitted to the excitor 152 to provide a vibration experience within safe durability limits of the excitor 152. Gain decision block 312 acts as a final arbiter of the signal state, comparing the summed history values against specific durability thresholds or K-values that have been converted from an excitor specification 122. Depending on these calculations, the gain decision block 312 sends a command to the GM block 306, which applies the gain reduction or muting to the signal path to generate the conditioned and protected output signal 320 that is provided to an excitor 152.

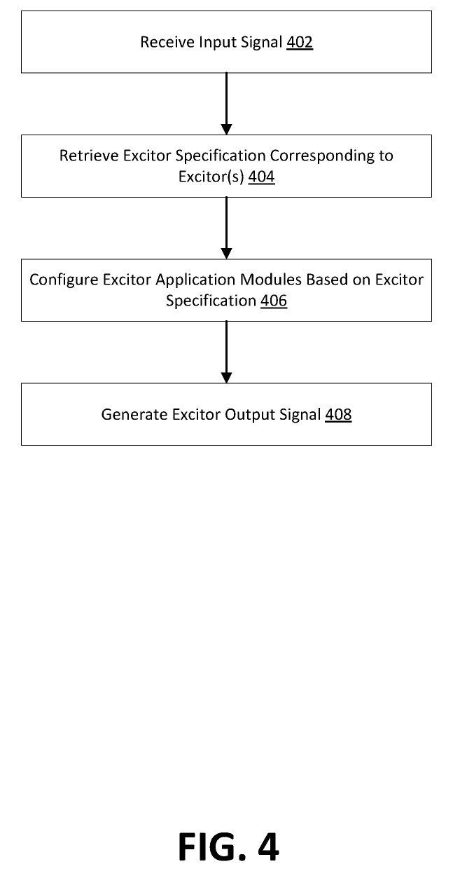

FIG. 4 is a flow diagram of method steps for implementing protection techniques for one or more excitors 152 according to various embodiments. Although method steps of the flow diagram illustrated in FIG. 4 are described in conjunction with embodiments of FIGS. 1-3, persons of ordinary skill in the art will understand that in some embodiments any system can be configured to perform method steps of the flow diagram of FIG. 4 in any order. In some embodiments, method steps of FIG. 4 can be implemented in hardware, software, and/or firmware.

The method 400 begins at step 402, where the excitor protection application 120 receives an input signal, which is typically an audio output signal from one or more input sources 150 of the multimedia system 100. The input signal can include music or multimedia content. In some embodiments, the input signal to the excitor protection application 120 can represent a pre-processed signal that specifies a desired vibration or shaking effect intended for a user’s seat or another surface within the vehicle, such as pane of glass or another surface that can be excited by an excitor 152.

At step 404, excitor protection application 120 retrieves an excitor specification 122 associated with one or more excitors 152 in the multimedia system 100. As noted above, excitor specifications 122 include operating parameters, operating limits, and other parameters from which the excitor protection application 120 can generate an excitor output signal that is consistent with the excitor specification 122 of a respective excitor 152. For example, the excitor specification 122 can specify an operating frequency range of an excitor 152, a peak voltage that the excitor 152 can accept, and duty cycle data that specify how long within a specified time period the excitor 152 can operate. An excitor specification 122 can vary significantly depending on the manufacturer or the specific seat location within a vehicle or theater of an excitor 152. An excitor specification 122 can be derived from supplier datasheets, define operating parameters such as the mechanical frequency range, rated and maximum voltages, and test data such as a required on/off ratio for cooling.

At step 406, excitor protection application 120 configures the various modules such as frequency band control module 303, dynamic gain limiter module 304, and TWPL module 305 of the excitor protection application 120. In one embodiment, a user or a developer can configure the excitor protection application 120 based on the excitor specification 122 of one or more excitors 152 that are utilized within an environment. The developer workflow for configuring the excitor protection application 120 involves translating an excitor specification 122 into functional software parameters for the configuring the excitor protection application 120 for a given implementation. The developer workflow begins with gathering the target excitor specification 122 from a manufacturer's datasheet or hardware durable test data. These excitor specifications 122 typically include the one or more excitors 152 respective maximum frequency range, normal operating voltage range, continuous maximum voltage time, and the required on/off ratio for cooling. During this configuration, the excitor protection application 120 determines which of the modules, such as frequency band control module 303, dynamic gain limiter module 304, and TWPL module 305, should be activated to generate a conditioned and protected output signal 320. For example, excitor protection application 120 can determine to disregard an operating frequency range or disable peak voltage protection if it determines that the incoming source signal is already guaranteed to be within a safe boundary for a particular excitor 152. Additionally, excitor protection application 120 can convert raw hardware test data in an excitor specification 122 into setting parameters for the frequency band control module 303, dynamic gain limiter module 304, and TWPL module 305, such as the mathematical K-values used by the TWPL module to decide when to initiate a gain reduction or a mute action.

The method 400 continues at step 408, where the excitor protection application 120 input signal 302 using the configured frequency band control module 303, dynamic gain limiter module 304, and TWPL module 305 to generate conditioned and protected output signal 320. Conditioned and protected output signal 320 is generated by applying gain folding, frequency filtering, and temporal power limiting to the input signal 302. By conditioning the input signal 302 in this way, the excitor protection application 120 prevents or limits the excitor 152 from overheating and avoids mechanical damage that would otherwise occur if the device were operated outside of a designed operating range. Because an excitor 152 is often installed in inaccessible locations, such as inside furniture or behind interior panels, excitor protection application 120 can maintain long-term system durability of an excitor 152 without requiring manual intervention or hardware replacement.

In sum, embodiments of the disclosure provide a software-based excitor protection module designed to safeguard excitors such as seat shakers from mechanical, electrical, and thermal failure by dynamically conditioning audio signals according to specific hardware tolerances. Unlike conventional speaker protection techniques which are often resource-intensive or unsuitable for the mechanical principles of vibrators, the disclosed techniques implement implements a configurable multi-stage processing pipeline. The pipeline includes Frequency Band Control (FBC) to enforce mechanical cutoff limits, a Dynamic Gain Limiter to regulate peak voltages, and a Time Window Power Limiter (TWPL) that tracks cumulative thermal stress by summing voltage window values against percentage-based K-value thresholds.

At least one technical advantage of the disclosed approach relative to the prior art is that, with the disclosed techniques, excitors are provided with protection without requiring hardware configuration changes to an audio system or the excitor components themselves. Implementing protection in hardware typically increases the unit cost, physical size, and mounting complexity of the excitor, which is a concern given the limited space available in locations where excitors are often installed. Additionally, the disclosed approach can accommodate various types of excitors from various manufacturers with varying operating parameters without reconfiguring the hardware components upstream of the excitors. These technical advantages provide one or more technological improvements over prior art approaches.

1. A computer-implemented method for excitor protection in a multimedia system, comprising receiving an audio output signal associated with an audio input signal; determining an excitor specification associated with an excitor, wherein the excitor specification specifies one or more operating parameters; and generating an excitor output signal based on the excitor specification.

2. The computer-implemented method of claim 1, wherein the excitor specification specifies an operating frequency range of the excitor and wherein the excitor output signal is generated within the operating frequency range.

3. The computer-implemented method of claim 2, wherein generating the excitor output signal comprises specifying at least one cutoff frequency for the excitor output signal based on the operating frequency range of the excitor.

4. The computer-implemented method of claim 2, wherein generating the excitor output signal comprises disregarding the operating frequency range in response to determining that the operating frequency range is larger than a possible frequency range of the excitor output signal.

5. The computer-implemented method of claim 1, wherein the excitor specification specifies an operating voltage parameter of the excitor.

6. The computer-implemented method of claim 5, wherein generating the excitor output signal comprises specifying a peak voltage for the excitor output signal based on the operating voltage parameter of the excitor.

7. The computer-implemented method of claim 5, wherein generating the excitor output signal comprises disregarding the operating voltage parameter in response to determining that a maximum peak voltage of the excitor is less than a possible maximum peak voltage of the excitor output signal.

8. The computer-implemented method of claim 1, wherein the excitor specification specifies at least one time window parameter of the excitor.

9. The computer-implemented method of claim 8, wherein generating the excitor output signal comprises limiting a signal gain in response to determining, via a time window power limiter (TWPL), that the excitor has exceeded the at least one time window parameter over a specified time period.

10. The computer-implemented method of claim 8, wherein generating the excitor output signal comprises muting the excitor output signal in response to determining, via a time window power limiter (TWPL), that the excitor has exceeded the at least one time window parameter over a specified time period.

11. The computer-implemented method of claim 8, wherein determining that the excitor has exceeded the at least one time window parameter comprises detecting a voltage level of the excitor output signal; counting a history power within a delay window; and comparing a summed window value against a predetermined threshold.

12. The computer-implemented method of claim 1, further comprising: driving a first type of excitor using a first software protection configuration that disables dynamic gain limiting; and driving a second type of excitor using a second software protection configuration that disables time window power limiting.

13. One or more non-transitory computer-readable media storing instructions that, when executed by one or more processors, cause the one or more processors to perform excitor protection in a multimedia system by performing the steps of: receiving an audio output signal associated with an audio input signal; determining an excitor specification associated with an excitor, wherein the excitor specification specifies one or more operating parameters; and generating an excitor output signal based on the excitor specification.

14. The one or more non-transitory computer-readable media of claim 13, wherein the excitor specification specifies an operating frequency range of the excitor and wherein the excitor output signal is generated within the operating frequency range.

15. The one or more non-transitory computer-readable media of claim 14, wherein generating the excitor output signal comprises specifying at least one cutoff frequency for the excitor output signal based on the operating frequency range of the excitor.

16. The one or more non-transitory computer-readable media of claim 13, wherein the excitor specification specifies an operating voltage parameter of the excitor.

17. The one or more non-transitory computer-readable media of claim 16, wherein generating the excitor output signal comprises specifying a peak voltage for the excitor output signal based on the operating voltage parameter of the excitor.

18. The one or more non-transitory computer-readable media of claim 13, wherein the excitor specification specifies at least one time window parameter of the excitor.

19. The one or more non-transitory computer-readable media of claim 18, wherein generating the excitor output signal comprises limiting a signal gain in response to determining, via a time window power limiter (TWPL), that the excitor has exceeded the at least one time window parameter over a specified time period.

20. A system comprising: at least one excitor; a memory storing instructions; and one or more processors, that when executing the instructions, are configured to perform excitor protection in a multimedia system by performing the steps of: receiving an audio output signal associated with an audio input signal; determining an excitor specification associated with an excitor, wherein the excitor specification specifies one or more operating parameters; and generating an excitor output signal based on the excitor specification.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for excitor protection in a multimedia system, comprising:
receiving an audio output signal associated with an audio input signal;
determining an excitor specification associated with an excitor, wherein the excitor specification specifies one or more operating parameters; and
generating an excitor output signal based on the excitor specification.

2. The computer-implemented method of claim 1, wherein the excitor specification specifies an operating frequency range of the excitor and wherein the excitor output signal is generated within the operating frequency range.

3. The computer-implemented method of claim 2, wherein generating the excitor output signal comprises specifying at least one cutoff frequency for the excitor output signal based on the operating frequency range of the excitor.

4. The computer-implemented method of claim 2, wherein generating the excitor output signal comprises disregarding the operating frequency range in response to determining that the operating frequency range is larger than a possible frequency range of the excitor output signal.

5. The computer-implemented method of claim 1, wherein the excitor specification specifies an operating voltage parameter of the excitor.

6. The computer-implemented method of claim 5, wherein generating the excitor output signal comprises specifying a peak voltage for the excitor output signal based on the operating voltage parameter of the excitor.

7. The computer-implemented method of claim 5, wherein generating the excitor output signal comprises disregarding the operating voltage parameter in response to determining that a maximum peak voltage of the excitor is less than a possible maximum peak voltage of the excitor output signal.

8. The computer-implemented method of claim 1, wherein the excitor specification specifies at least one time window parameter of the excitor.

9. The computer-implemented method of claim 8, wherein generating the excitor output signal comprises limiting a signal gain in response to determining, via a time window power limiter (TWPL), that the excitor has exceeded the at least one time window parameter over a specified time period.

10. The computer-implemented method of claim 8, wherein generating the excitor output signal comprises muting the excitor output signal in response to determining, via a time window power limiter (TWPL), that the excitor has exceeded the at least one time window parameter over a specified time period.

11. The computer-implemented method of claim 8, wherein determining that the excitor has exceeded the at least one time window parameter comprises:
detecting a voltage level of the excitor output signal;
counting a history power within a delay window; and
comparing a summed window value against a predetermined threshold.

12. The computer-implemented method of claim 1, further comprising:
driving a first type of excitor using a first software protection configuration that disables dynamic gain limiting; and
driving a second type of excitor using a second software protection configuration that disables time window power limiting.

13. One or more non-transitory computer-readable media storing instructions that, when executed by one or more processors, cause the one or more processors to perform excitor protection in a multimedia system by performing the steps of:
receiving an audio output signal associated with an audio input signal;
determining an excitor specification associated with an excitor, wherein the excitor specification specifies one or more operating parameters; and
generating an excitor output signal based on the excitor specification.

14. The one or more non-transitory computer-readable media of claim 13, wherein the excitor specification specifies an operating frequency range of the excitor and wherein the excitor output signal is generated within the operating frequency range.

15. The one or more non-transitory computer-readable media of claim 14, wherein generating the excitor output signal comprises specifying at least one cutoff frequency for the excitor output signal based on the operating frequency range of the excitor.

16. The one or more non-transitory computer-readable media of claim 13, wherein the excitor specification specifies an operating voltage parameter of the excitor.

17. The one or more non-transitory computer-readable media of claim 16, wherein generating the excitor output signal comprises specifying a peak voltage for the excitor output signal based on the operating voltage parameter of the excitor.

18. The one or more non-transitory computer-readable media of claim 13, wherein the excitor specification specifies at least one time window parameter of the excitor.

19. The one or more non-transitory computer-readable media of claim 18, wherein generating the excitor output signal comprises limiting a signal gain in response to determining, via a time window power limiter (TWPL), that the excitor has exceeded the at least one time window parameter over a specified time period.

20. A system comprising:
at least one excitor;
a memory storing instructions; and
one or more processors, that when executing the instructions, are configured to perform excitor protection in a multimedia system by performing the steps of:
receiving an audio output signal associated with an audio input signal;
determining an excitor specification associated with an excitor, wherein the excitor specification specifies one or more operating parameters; and
generating an excitor output signal based on the excitor specification.
